(19) United States
(12) Patent Application Publication
(10) Pub. No.: US 2023/0283349 A1
(43) Pub. Date: Sep. 7, 2023

(54) METHOD AND APPARATUS FOR UL TRANSMISSION

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 18/171,233

(22) Filed: Feb. 17, 2023

Related U.S. Application Data
(60) Provisional application No. 63/316,833, filed on Mar. 4, 2022.
(60) Provisional application No. 63/445,614, filed on Feb. 14, 2023.

(51) Int. Cl. H04B 7/06; H04W 72/23

(52) U.S. Cl. CPC H04B 7/0639; H04B 7/0695; H04W 72/23

(57) ABSTRACT

Apparatuses and methods for uplink (UL) transmission are provided. A method for operating a user equipment (UE) includes receiving information about an uplink (UL) transmission based on N antenna ports and receiving a first indicator (I) indicating G groups of antenna ports, g₁, . . . , g_{G}. Group gᵢ includes nᵢ antenna ports selected from the N antenna ports. The method further includes identifying, based on the information and the first indicator (I), the G groups and transmitting the UL transmission based on the identified G groups. Here,

$$i = 1 , … , G ,$$

$$N ∈ \{ 2 , 4 , 6 , 8 , 12 , 16 \} ,$$

$$G ∈ \{ 1 , 2 , 3 , 4 , 6 , 8 , 12 , 16 \} ,$$

$$G \leq N ,$$

$$and$$

$${n}_{i} = \frac{N}{G} .$$

### CROSS-REFERENCE TO RELATED APPLICATION AND CLAIM OF PRIORITY

This application claims priority under 35 U.S.C. § 119(e) to U.S. Provisional Patent Application No. 63/316,833 filed on Mar. 4, 2022, and U.S. Provisional Patent Application No. 63/445,614 filed on Feb. 14, 2023. The above-identified provisional patent applications are hereby incorporated by reference in their entirety.

### TECHNICAL FIELD

The present disclosure relates generally to wireless communication systems and, more specifically, to uplink transmission.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for uplink transmission.

In one embodiment, a user equipment (UE) is provided. The UE includes a transceiver configured to receive information about an uplink (UL) transmission based on N antenna ports and receive a first indicator (I) indicating G groups of antenna ports, g₁, . . . , g_{G}. Group gᵢ includes nᵢ antenna ports selected from the N antenna ports. The UE further includes a processor operably coupled to the transceiver. The processor is configured to identify, based on the information and the first indicator (I), the G groups. The transceiver is further configured to transmit the UL transmission based on the identified G groups

$$i = 1 , … , G ,$$

$$N ∈ \{ 2 , 4 , 6 , 8 , 12 , 16 \} ,$$

$$G ∈ \{ 1 , 2 , 3 , 4 , 6 , 8 , 12 , 16 \} ,$$

$$G \leq N ,$$

$$and$$

$${n}_{i} = \frac{N}{G} .$$

In another embodiment, a base station (BS) is provided. The BS includes a processor configured to generate information about an UL transmission based on N antenna ports. The BS further includes a transceiver operably coupled to the processor. The transceiver is configured to transmit the information and transmit a first indicator (I) indicating G groups of antenna ports, g₁, . . . , g_{G}. Group gᵢ includes nᵢ antenna ports selected from the N antenna ports. The transceiver is further configured to receive the UL transmission.

$$i = 1 , … , G ,$$

$$N ∈ \{ 2 , 4 , 6 , 8 , 12 , 16 \} ,$$

$$G ∈ \{ 1 , 2 , 3 , 4 , 6 , 8 , 12 , 16 \} ,$$

$$G \leq N ,$$

$$and$$

$${n}_{i} = \frac{N}{G} .$$

In yet another embodiment, a method for operating a UE is provided. The method includes receiving information about an UL transmission based on N antenna ports and receiving a first indicator (I) indicating G groups of antenna ports, g₁, . . . , g_{G}. Group gᵢ includes nᵢ antenna ports selected from the N antenna ports. The method further includes identifying, based on the information and the first indicator (I), the G groups and transmitting the UL transmission based on the identified G groups.

$$i = 1 , … , G ,$$

$$N ∈ \{ 2 , 4 , 6 , 8 , 12 , 16 \} ,$$

$$G ∈ \{ 1 , 2 , 3 , 4 , 6 , 8 , 12 , 16 \} ,$$

$$G \leq N ,$$

$$and$$

$${n}_{i} = \frac{N}{G} .$$

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4 and 5 illustrate example wireless transmit and receive paths according to embodiments of the present disclosure;

FIG. 6 illustrates an example antenna blocks or arrays forming beams according to embodiments of the present disclosure;

FIG. 7 illustrates an example antenna port layout according to embodiments of the present disclosure;

FIG. 8 illustrates an example antenna panel according to embodiments of the present disclosure; and

FIG. 9 illustrates another example antenna panel according to embodiments of the present disclosure; and

FIG. 10 illustrates an example method for UL transmission in a wireless communication system according to embodiments of the present disclosure.

### DETAILED DESCRIPTION

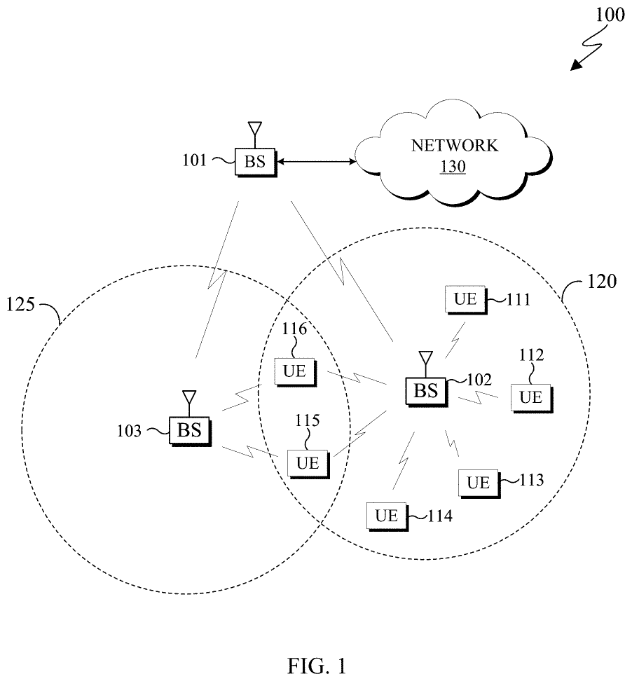

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v 17.0.0, “E-UTRA, Physical channels and modulation” (herein “REF 1”); 3GPP TS 36.212 v 17.0.0, “E-UTRA, Multiplexing and Channel coding” (herein “REF 2”); 3GPP TS 36.213 v 17.0.0, “E-UTRA, Physical Layer Procedures” (herein “REF 3”); 3GPP TS 36.321 v 17.0.0, “E-UTRA, Medium Access Control (MAC) protocol specification” (herein “REF 4”); 3GPP TS 36.331 v 17.0.0, “E-UTRA, Radio Resource Control (RRC) protocol specification” (herein “REF 5”); 3GPP TS 38.211 v 17.0.0, “NR, Physical channels and modulation” (herein “REF 6”); 3GPP TS 38.212 v 17.0.0, “NR, Multiplexing and Channel coding” (herein “REF 7”); 3GPP TS 38.213 v 17.0.0, “NR, Physical Layer Procedures for Control” (herein “REF 8”); 3GPP TS 38.214 v 17.0.0, “NR, Physical Layer Procedures for Data” (herein “REF 39); 3GPP TS 38.215 v 17.0.0, “NR, Physical Layer Measurements” (herein “REF 10”); 3GPP TS 38.321 v 17.0.0, “NR, Medium Access Control (MAC) protocol specification” (herein “REF 11”); 3GPP TS 38.331 v 17.0.0, “NR, Radio Resource Control (RRC) Protocol Specification (herein REF 12)”.

Wireless communication has been one of the most successful innovations in modem history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), gNB, a macrocell, a femtocell, a WiFi access point (AP), or other wirelessly enabled devices. Base stations may provide wireless access in accordance with one or more wireless communication protocols, e.g., 5G 3GPP New Radio Interface/Access (NR), long term evolution (LTE), LTE advanced (LTE-A), High Speed Packet Access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting uplink transmission. In certain embodiments, one or more of the BSs 101-103 include circuitry, programing, or a combination thereof for supporting uplink transmission.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

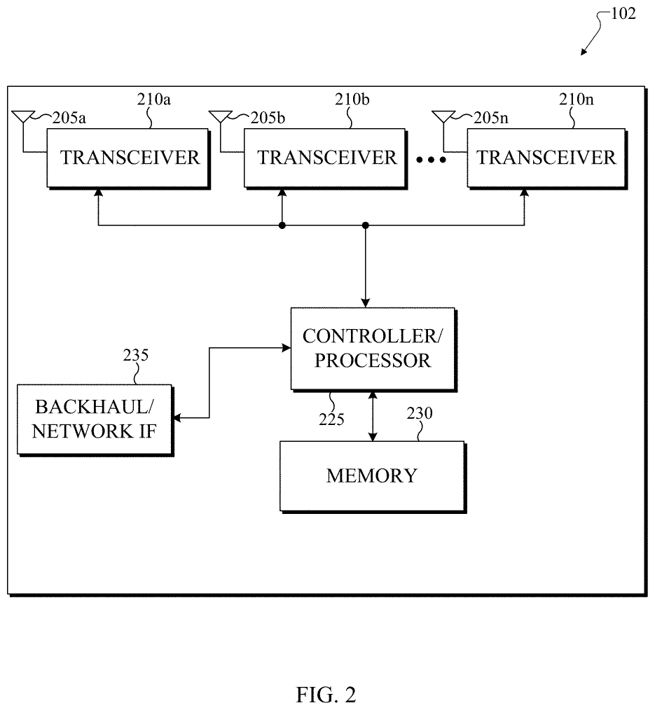

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for uplink transmission. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

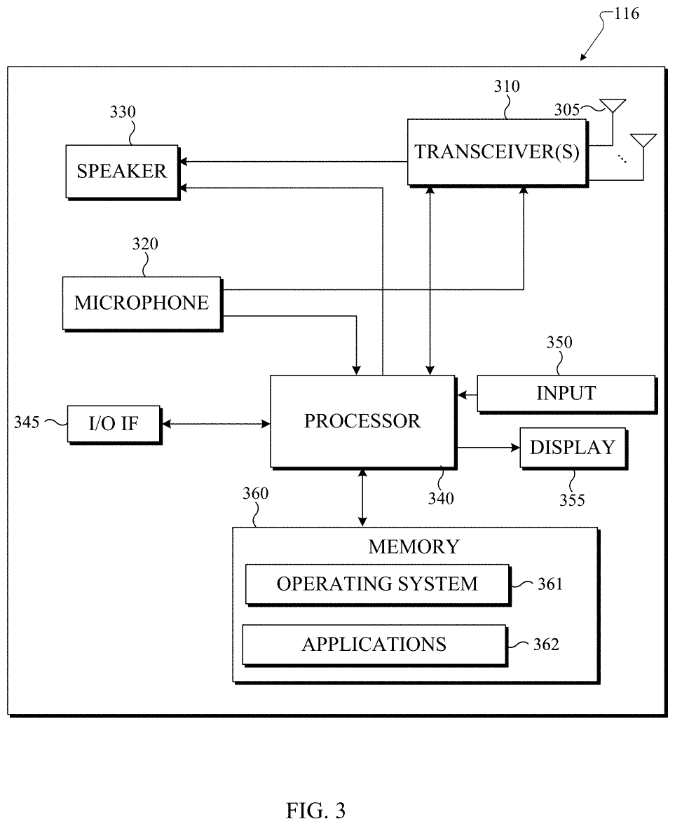

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

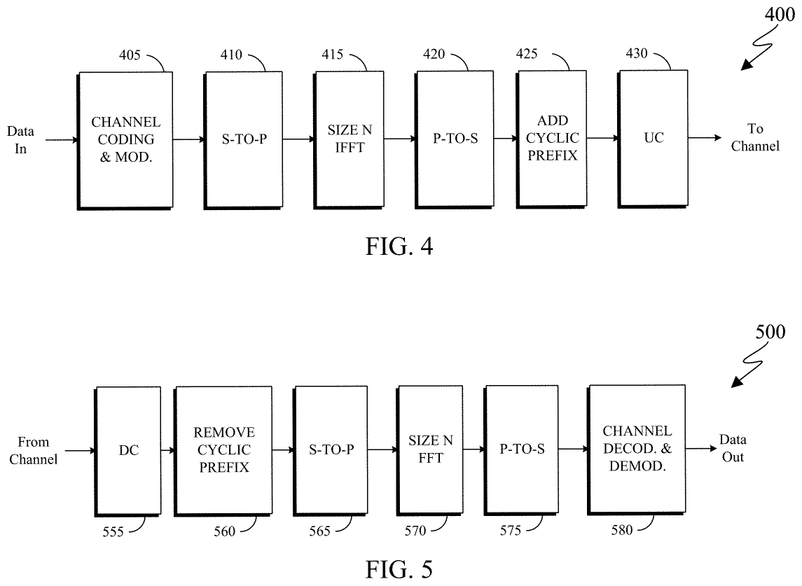

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support uplink transmission as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

The 3GPP NR specification supports up to 32 CSI-RS antenna ports which enable an eNB (or gNB) to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase. For UL transmission, the 3GPP specification supports 1, 2, or 4 SRS antenna ports in one SRS resource, where each SRS antenna port can be mapped to one or multiple antenna elements at the UE.

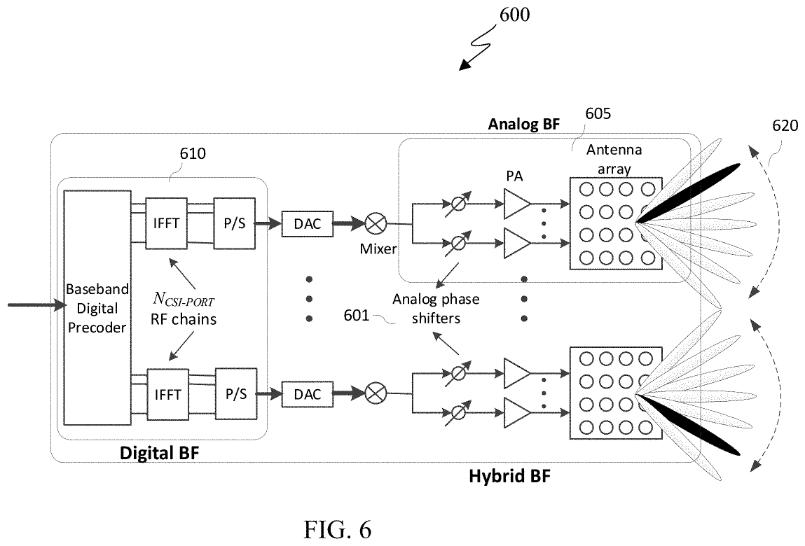

FIG. 6 illustrates an example antenna blocks or arrays 600 according to embodiments of the present disclosure. The embodiment of the antenna blocks or arrays 600 illustrated in FIG. 6 is for illustration only. FIG. 6 does not limit the scope of this disclosure to any particular implementation of the antenna blocks or arrays.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6. In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

Embodiments of the present disclosure recognize and take into consideration that, in NR, two transmission schemes are supported for PUSCH: codebook based transmission and non-codebook based transmission. The UE is configured with codebook based transmission when the higher layer parameter txConfig in pusch-Config is set to ‘codebook’, the UE is configured non-codebook based transmission when the higher layer parameter txConfig is set to ‘nonCodebook’.

According to Section 6.1.1.1 [REF9], the following is supported for codebook based UL transmission.

For codebook based transmission, PUSCH can be scheduled by DCI format 0_0, DCI format 0_1, DCI format 0_2 or semi-statically configured to operate according to Clause 6.1.2.3 [REF9]. If this PUSCH is scheduled by DCI format 0_1, DCI format 0_2, or semi-statically configured to operate according to Clause 6.1.2.3 [REF9], the UE determines its PUSCH transmission precoder based on SRI, TPMI and the transmission rank, where the SRI, TPMI and the transmission rank are given by DCI fields of SRS resource indicator and Precoding information and number of layers in clause 7.3.1.1.2 and 7.3.1.1.3 of [5, REF] for DCI format 0_1 and 0_2 or given by srs-ResourceIndicator and precodingAndNumberOfLayers according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one SRS resource set can be configured in srs-ResourceSetToAddModList with higher layer parameter usage in SRS-ResourceSet set to ‘codebook’, and only one SRS resource set can be configured in srs-ResourceSetToAddModListDCI-0-2 with higher layer parameter usage in SRS-ResourceSet set to ‘codebook’. The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [4, TS 38.211]. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the PDCCH carrying the SRI.

For codebook-based transmission, the UE determines its codebook subsets based on TPMI and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fullyAndPartialAndNonCoherent’, or ‘partialAndNonCoherent’, or ‘nonCoherent’ depending on the UE capability. When higher layer parameter ul-FullPowerTransmission is set to ‘fullpowerMode2’ and the higher layer parameter codebookSubset or the higher layer parameter codebookSubsetForDCI-Format0-2 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission shall not expect to be configured by either codebookSubset or codebookSubsetForDCI-Format0-2 with ‘fullyAndPartialAndNonCoherent’.

A UE reporting its UE capability of ‘nonCoherent’ transmission shall not expect to be configured by either codebookSubset or codebookSubsetForDCI-Format0-2 with ‘fullyAndPartialAndNonCoherent’ or with ‘partialAndNonCoherent’.

A UE shall not expect to be configured with the higher layer parameter codebookSubset or the higher layer parameter codebookSubsetForDCI-Format0-2 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook-based transmission, only one SRS resource can be indicated based on the SRI from within the SRS resource set. Except when higher layer parameter ul-FullPowerTransmission is set to ‘fullpowerMode2’, the maximum number of configured SRS resources for codebook-based transmission is 2. If aperiodic SRS is configured for a UE, the SRS request field in DCI triggers the transmission of aperiodic SRS resources.

A UE shall not expect to be configured with higher layer parameter ul-FullPowerTransmission set to ‘fullpowerModel’ and codebookSubset or codebookSubsetDCI-0-2 set to ‘fullAndPartialAndNonCoherent’ simultaneously.

The UE shall transmit PUSCH using the same antenna port(s) as the SRS port(s) in the SRS resource indicated by the DCI format 0_1 or 02 or by configuredGrantConfig according to clause 6.1.2.3.

The DM-RS antenna ports {\tilde{p}₀, . . . , \tilde{p}ᵥ₋₁} in Clause 6.4.1.1.3 of [4, TS38.211] are determined according to the ordering of DM-RS port(s) given by Tables 7.3.1.1.2-6 to 7.3.1.1.2-23 in Clause 7.3.1.1.2 of [5, TS 38.212].

Except when higher layer parameter ul-FullPowerTransmission is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for all these SRS resources.

In the remainder of the present disclosure, ‘fullAndPartialAndNonCoherent’, ‘partialAndNonCoherent’, and ‘Non-Coherent’ are referred to codebookSubsets depending on three coherence type/capability, where the term ‘coherence’ implies all or a subset of antenna ports at the UE that can be used to transmit a layer coherently. In particular,
the term ‘full-coherence’ (FC) implies all antenna ports at the UE that can be used to transmit a layer coherently.
the term ‘partial-coherence’ (PC) implies a subset (at least two but less than all) of antenna ports at the UE that can be used to transmit a layer coherently.
the term ‘non-coherence’ (NC) implies only one antenna port at the UE that can be used to transmit a layer.

When the UE is configured with codebookSubset=‘fullAndPartialAndNonCoherent’, the UL codebook includes all three types (FC, PC, NC) of precoding matrices; when the UE is configured with codebookSubset=‘partialAndNonCoherent’, the UL codebook includes two types (PC, NC) of precoding matrices; and when the UE is configured with codebookSubset=‘nonCoherent’, the UL codebook includes only one type (NC) of precoding matrices.

According to Section 6.3.1.5 of REF7, for non-codebook-based UL transmission, the precoding matrix W equals the identity matrix. For codebook-based UL transmission, the precoding matrix W is given by W=1 for single-layer transmission on a single antenna port, otherwise by Table 1 to Table 6, which are copied below.

The rank (or number of layers) and the corresponding precoding matrix _{w} are indicated to the UE using TRI and TPMI, respectively. In one example, this indication is joint via a field ‘Precoding information and number of layers’ in DCI, e.g., using DCI format 0_1. In another example, this indication is via higher layer RRC signaling. In one example, the mapping between a field ‘Precoding information and number of layers’ and TRI/TPMI is according to Section 7.3.1.1.2 of [REF10].

TABLE 1
Precoding matrix W for single-layer transmission using two antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2
Precoding matrix W for single-layer transmission using
four antenna ports with transform precoding disabled.

| TPMI | W | | | | | | | |
|---|---|---|---|---|---|---|---|---|
| index | (ordered from left to right in increasing order of TPMI index) | | | | | | | |
| 0-5 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 3
Precoding matrix W for two-layer transmission using
two antenna ports with transform precoding disabled.

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 4
Precoding matrix W for two-layer transmission using
four antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 5
Precoding matrix W for three-layer transmission using
four antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6
Precoding matrix W for four-layer transmission using
four antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The subset of TPMI indices for the three coherence types are summarized in Table 7 and Table 8, where rank=r corresponds to (and is equivalent to) r layers.

TABLE 7
Total power of precoding matrix W for 2 antenna ports

| | Non-Coherent (NC) TPMIs | | Full-Coherent (FC) TPMIs | |
|---|---|---|---|---|
| | TPMI | Total | TPMI | Total |
| Rank | indices | power | indices | power |
| 1 | 0-1 | ½ | 2-5 | 1 |
| 2 | 0 | 1 | 1-2 | 1 |

TABLE 8
Total power of precoding matrix W for 4 antenna ports

| | Non-Coherent | | Partial-Coherent | | Full-Coherent | |
|---|---|---|---|---|---|---|
| | (NC) TPMIs | | (PC) TPMIs | | (FC) TPMIs | |
| | TPMI | Total | TPMI | Total | TPMI | Total |
| Rank | indices | power | indices | power | indices | power |
| 1 | 0-3 | ¼ | 4-11 | ½ | 12-27 | 1 |
| 2 | 0-5 | ½ | 6-13 | 1 | 14-21 | 1 |
| 3 | 0 | ¾ | 1-2 | 1 | 3-6 | 1 |
| 4 | 0 | 1 | 1-2 | 1 | 3-4 | 1 |

The corresponding supported codebookSubsets are summarized in Table 9 and Table 10.

TABLE 9
TPMI indices for codebookSubsets for 2 antenna ports

| Rank | Non-Coherent | fullAndPartialAndNonCoherent |
|---|---|---|
| 1 | 0-1 | 0-5 |
| 2 | 0 | 0-2 |

TABLE 10
TPMI indices for codebookSubsets for 4 antenna ports

| | Non- | | |
|---|---|---|---|
| Rank | Coherent | partialAndNonCoherent | fullAndPartialAndNonCoherent |
| 1 | 0-3 | 0-11 | 0-27 |
| 2 | 0-5 | 0-13 | 0-21 |
| 3 | 0 | 0-2 | 0-6 |
| 4 | 0 | 0-2 | 0-4 |

In up to Rel. 17 NR, for UL transmission, the 3GPP specification supports 1, 2, or 4 SRS antenna ports in one SRS resource. In more advanced UL MIMO systems (e.g., in Rel. 18 and beyond), the number of SRS antenna ports can be more than 4, e.g., 6, 8, or even 12, and 16, especially for devices such as CPE, FWA, and vehicular UEs. The UL transmission for such devices requires enhancements, e.g., antenna port group selection and codebook for the selected antenna ports, and related signaling for efficient UL MIMO operations. The present disclosure provides example embodiments for potential enhancements. The scope of the present disclosure is not limited to only these embodiments but includes any extensions or combinations of the proposed embodiments.

Accordingly, various embodiments of the present disclosure provide an UL transmission scheme. In various embodiments, selection of a group/subset of antenna ports (at the UE), and UL precoding for the selected antenna ports is provided. In various embodiments, indication/signaling related to the antenna port group/subset selection and UL precoding is provided. In various embodiments, codebook for the selected group/subset of antenna ports is provided. In various embodiments, extension to simultaneous transmission from multiple antenna panels, to multiple TRPs is provided.

For a given antenna panel at the UE, (that can be located at one plane, side, or edge of the UE), let N₁ and N₂ be the number of antenna ports with the same polarization in the first and second dimensions, respectively, of the antenna panel. For 2D antenna port layouts, we have N₁>1, N₂>1, and for 1D antenna port layouts, we either have N₁>1 and N₂=1 or N₂>1 and N₁=1. In the remainder of the present disclosure, 1D antenna port layouts with N₁>1 and N₂=1 is considered. The present disclosure, however, is applicable to the other 1D port layouts with N₂>1 and N₁=1. Also, in the remainder of the present disclosure, we assume that N₁>N₂. The present disclosure, however, is applicable to the case when N₁<N₂, and the embodiments for N₁>N₂ applies to the case N₁<N₂ by swapping/switching (N₁, N₂) with (N₂, N₁). For a (single-polarized) co-polarized antenna port layout, the total number of antenna ports is N₁N₂ and for a dual-polarized antenna port layout, the total number of antenna ports is 2N₁N₂. An illustration of antenna port layouts for {2, 4, 6, 8, 12} antenna ports at UE is shown in Table 11.

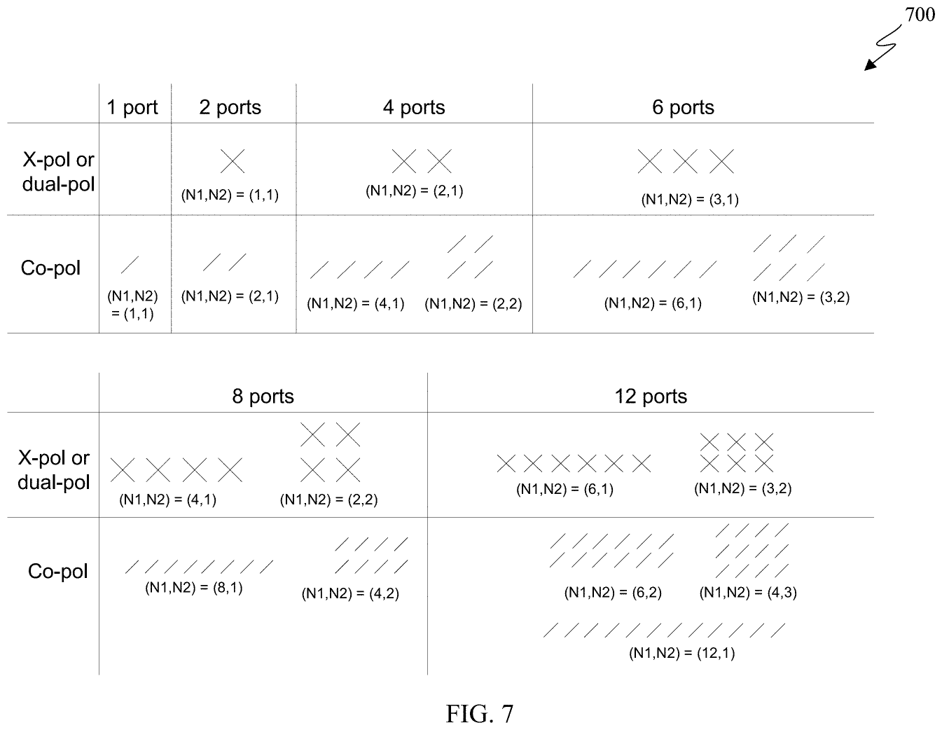

FIG. 7 illustrates an example antenna port layout 700 according to embodiments of the present disclosure. The embodiment of the antenna port layout 700 illustrated in FIG. 9 is for illustration only. FIG. 7 does not limit the scope of this disclosure to any particular implementation of the antenna port layout 700.

Let s denote the number of antenna polarizations (or groups of antenna ports with the same polarization). Then, for co-polarized antenna ports, s=1, and for dual- or cross (X)-polarized antenna ports s=2. So, the total number of antenna ports P=sN₁N₂. In one example, the antenna ports at the UE refers to SRS antenna ports (either in one SRS resource or across multiple SRS resources). In one example, the notation P and N are used interchangeably to denote the number of antenna ports at the UE. Each antenna panel may have a structure as shown in FIG. 7.

In one embodiment, the UL codebook W for P antenna ports at the UE is based on pre-coding vectors which are according to one of the two alternatives in Table 11 depending on whether the antenna ports are co-polarized or cross-/dual-polarized.

TABLE 11
Pre-coding vectors

| Co-pol | Dual-pol |
|---|---|
| ${v}_{l , m} = \frac{{v}_{l , m}}{\sqrt{{N}_{1} {N}_{2}}}$ | ${v}_{l , m , n} = \frac{1}{\sqrt{2 {N}_{1} {N}_{2}}} [ \begin{matrix}{v}_{l , m} \\ {φ}_{n} {v}_{l , m}\end{matrix} ]$ |

Here, v_{l,m} is a Kronecker product (⊗) of vectors wₗ and uₘ of lengths N₁ and N₂, respectively. In one example, wₗ and uₘ are oversampled DFT vectors, i.e.,

$${w}_{l} = {[ \begin{matrix}1 & {e}^{j \frac{2 π l}{{O}_{1} {N}_{1}}} & {e}^{j \frac{4 π l}{{O}_{1} {N}_{1}}} & ⋯ & {e}^{j \frac{2 π l ( {N}_{1} - 1 )}{{O}_{1} {N}_{1}}}\end{matrix} ]}^{T}$$

$${u}_{m} = \{ \begin{matrix}[ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}} ]}\end{matrix} & {N}_{2} > 1 \\ 1 & {N}_{2} = 1\end{matrix}$$

where O₁ and O₂ are oversampling factors in two dimensions, and v_{l,m} is then given by

$${v}_{l , m} = {w}_{l} ⊗ {u}_{m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ]}^{T}$$

In one example, both O₁, O₂∈{1, 2, 4, 8}. In one example, O₁ and O₂ can take the same values as Rel.15 NR Type I codebook (cf. 5.2.2.2.1, TS 38.214), i.e., (O₁, O₂)=(4,4) when N₂>1, and, i.e., (O₁, O₂)=(4,1) when N₂=1. Alternatively, they take different values from the Rel. 15 Type I NR codebook, for example, (O₁, O₂)=(2,2) when N₂>1, and, i.e., (O₁, O₂)=(2,1) when N₂=1. In one example, O₁ and O₂ is configurable (e.g., via higher layer). In one example, (O₁, O₂)=(2,2) when (N₁, N₂)=(2,2). In one example, (O₁, O₂)=(2,2) when (N₁, N₂)=(2,1). In one example, (O₁, O₂)=(1,1) when (N₁, N₂)=(2,2). In one example, (O₁, O₂)=(1,1) when (N₁, N₂)=(4,1). In one example, NᵢOᵢ=v, when Nᵢ>1, where i=1, 2, and v is fixed value (e.g., 4 or 8), or is configured (e.g., via RRC from {4, 8}).

The quantity φₙ is a co-phase for dual-polarized antenna port layouts. In one example, φₙ=e^{jπn/2}, where n∈{0, 1, 2, 3} implying that φₙ belongs to QPSK alphabet {1, j, −1, −j}.

In one example, the values of N₁ and N₂ are configured, e.g., with the higher layer parameter n1-n2-ul. The supported configurations of (N₁, N₂) for a given number of antenna ports (P) is given in Table 12. The UE can report one or multiple values of (N₁, N₂) that the UE can support via a UE capability information reporting, and the UE is configured with one (N₁, N₂) values when the supports multiple values of (N₁, N₂). For example, for N=8, the UE can report one of or both of (4,1) and (2,2) in its capability reporting.

TABLE 12
Configurations of (N₁, N₂)

| Number of | Dual-pol | Co-pol |
|---|---|---|
| antenna ports, P | (N₁, N₂) | (N₁, N₂) |
| 2 | (1, 1) | (2, 1) |
| 4 | (2, 1) | (2, 2), (4, 1) |
| 6 | (3, 1) | (3, 2), (6, 1) |
| 8 | (2, 2), (4, 1) | (4, 2), (8, 1) |
| 12 | (3, 2), (6, 1) | (4, 3), (6, 2), (12, 1) |
| 16 | (4, 2), (8, 1) | (8, 2), (4, 4), (16, 1) |

In one example, the values of N₁ and N₂ are fixed for a given number of antenna ports. For example, (N₁, N₂)=(P, 1) for co-pol and

$$( \frac{P}{2} , 1 )$$

for dual-pol antenna. In one example, only one (N₁, N₂) is supported for each value of P, where the supported (N₁, N₂) is one of pairs in Table 12.

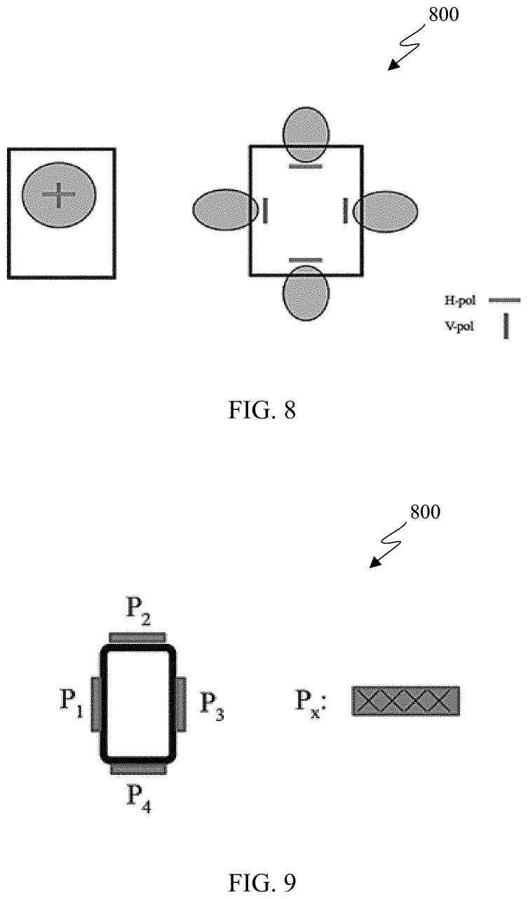

The term ‘antenna panel’ refers to a group of antenna ports or a group of antenna elements or a subset of antenna ports associated with a resource (e.g., SRS resource, CSI-RS resource, SSB block). Two examples are shown in FIG. 8, the first example (left) has a single panel comprising a dual-polarized (i.e., two) antennae/ports, and the second example has four panels each comprising a single antenna/ports (pointing in four different directions). Another example is shown in FIG. 9 wherein there are four antenna panels (on opposite sides), each comprising four dual-polarized antennae/ports. The antenna structure of each antenna panel can be as described above.

In one embodiment, a UE is configured with an UL transmission (e.g., via PUSCH-Config), which can be granted/triggered dynamically by UL-DCI (e.g., format 0_1 and 0_2) or semi-statically (e.g., configured-grant). The UE is indicated with a group/subset of n antenna ports selected from a total of N antenna ports at the UE, where n≤N. The UE identifies a group/subset of n antenna ports, then transmits the UL transmission based on the identified the group/subset of n antenna ports. When n=N, the group comprises all N antenna ports. In one example, n divides N, i.e.,

$$n = \frac{N}{G} ,$$

where G is a number of groups each comprising n antenna ports. In one example, the candidate value of n is

$$n = \frac{N}{G}$$

$$where$$

$$N ∈ \{ 2 , 4 , 6 , 8 , 12 , 16 \} ,$$

$$G ∈ \{ 1 , 2 , 3 , 4 , 6 , 8 , 12 , 16 \} ,$$

$$G \leq N .$$

For a codebook-based UL transmission, the UE can be further indicated with a precoding matrix and a number of layers for the UL transmission, where the precoding matrix corresponds to (or is associated with or is for) the selected group/subset of n antenna ports, i.e., the number of rows of the precoding matrix or the number of non-zero rows of the precoding matrix equals n. The UE transmits the UL transmission based on the identified the group/subset of n antenna ports, the precoding matrix and the number of layers.

In one example, the group/subset of n antenna ports is indicated via an indicator I. In one example, the indicator I is (or is associated with or corresponds to) an SRI or a component of SRI (e.g., when SRI is indicated via DCI). In one example, the indicator is (or is associated with or corresponds to) srs-ResourceIndicator a component of srs-ResourceIndicator (e.g., when srs-ResourceIndicator is indicated via higher layer). In one example, the indicator I is included in (or is associated with or corresponds to) a TPMI/TRI (transmit PMI and transmission rank) or a component of TPMI/TRI (e.g., when TPMI/TRI is indicated via DCI). In one example, the indicator J is included in precodingAndNumberOfLayers or a component of precodingAndNumberOfLayers (e.g., when precodingAndNumberOfLayers is indicated via higher layer).

In one example, the precoding matrix is indicated via an indicator J. In one example, the indicator J is a TPMI/TRI (transmit PMI and transmission rank) or a component of TPMI/TRI (e.g., when TPMI/TRI is indicated via DCI). In one example, the indicator J is precodingAndNumberOfLayers or a component of precodingAndNumberOfLayers (e.g., when precodingAndNumberOfLayers is indicated via higher layer).

In one example, there are two separate indicators, one for the indicator I, and another for the indicator J. In one example, they are indicated via the same medium/channel, e.g., both via DCI or both via higher layer (RRC) or both via MAC CE. In one example, they are indicated via two different channels/mediums, e.g., the indicator I via higher layer or MAC CE and the indicator J via DCI, or the indicator I via higher layer or DCI and the indicator J via MAC CE, or the indicator I via DCI or MAC CE and the indicator J via higher layer.

In one example, there is one joint indicator K indicating both the group for the selection of n antenna ports, and the precoding matrix. In one example, the joint indicator K is a TPMI or a component of TPMI (e.g., when TPMI is indicated via DCI) or srs-ResourceIndicator a component of srs-ResourceIndicator (e.g., when srs-ResourceIndicator is indicated via higher layer). In one example, the joint indicator K is indicated via MAC CE. In one example, the TPMI or one of its components or srs-ResourceIndicator or one of its components indicates a precoding matrix having both zero and non-zero rows, where the number of non-zero rows corresponds to (indicates) the value of n, and the row indices of the non-zero rows correspond to (indicates) the selected n antenna ports, and the concatenation of all non-zero rows corresponds to (indicates) the precoding matrix for the selected n antenna ports.

In one example, the indicator (I) and the indicator (J) are encoded in one joint field of a medium or in two separate fields of the medium or two mediums, where:
the one joint field is associated with an SRI or a TPMI,
the two separate fields are associated with an SRI and a TPMI, respectively,
the medium is one of an RRC message, a MAC CE, and a DCI, and
the two mediums correspond to two of an RRC message, a MAC CE, and a DC.

In one example, the TPMI/TRI is indicated via a DCI field, e.g., a field Precoding information and number of layers in DCI format 0_1 and 0_2. In one example, the TPMI/TRI is indicated via a higher layer parameter, e.g., precodingAndNumberOfLayers. In one example, the TPMI/TRI is indicated via a MAC CE. In one example, the SRI is indicated via a DCI field, e.g., an SRI field in DCI format 0_1 and 0_2. In one example, the SRI is indicated via a higher layer parameter, e.g., srs-ResourceIndicator. In one example, the SRI is indicated via a MAC CE.

In one example, at least one of the following examples is used/configured regarding the groups/subsets of antenna ports.
In one example, n divides N and a group/subset of antenna ports comprises n consecutive antenna ports. For example, when N=4 and n=2, there are two groups/subsets (G=2), a first group/subset g₁ comprises antenna ports {1, 2} and a second group/subset g₂ comprises antenna ports {3, 4}.
In one example, a group/subset of antenna ports comprises uniformly-spaced antenna ports with a spacing s between two consecutive (adjacent) antenna ports in the subset/group. For example, when s=2, a first group/subset g₁ comprises even-numbered {2, 4, . . . } antenna ports, and a second group/subset g₂ comprises odd-numbered {1, 3, . . . } antenna ports, and so on. For example, when s=4, a first group/subset g₁ comprises {1, 5, . . . } antenna ports, and a second group/subset g₂ comprises {2, 6, . . . } antenna ports, and so on.
In one example, a group/subset of antenna ports is selected freely. In one example, any n out of N antenna ports can be selected. In one example, for a dual-polarized antenna ports, the antenna ports are divided into two polarizations (e.g., 1, . . . , N/2 with one polarization and

$$\frac{N}{2} + 1 , … , N$$

with another polarization), and for the first polarization, any

$$\frac{n}{2}$$

out of

$$\frac{N}{2}$$

antenna ports can be selected, and for the second polarization, the selected antenna ports are obtained by adding N/2 to the indices of the selected antenna ports from the first polarization. In one example, a bitmap of length N (or N/2) bits is used to indicate the free selection of the group/subset of n antenna ports. The bitmap includes n (or n/2) ones ‘1’ and N−n (or N/2−n/2) zeros ‘0’, and the indices (locations) of ones ‘1’ indicate the group/subset of n (or n/2) antenna ports. In one example, a combinatorial index is used to indicate the free selection of the group/subset of n antenna ports. For a given n and N, the payload of the combinatorial index is

$$⌈ {log}_{2} ( \begin{matrix}N \\ n\end{matrix} ) ⌉$$

$$or$$

$$⌈ {log}_{2} ( \begin{matrix}N / 2 \\ n / 2\end{matrix} ) ⌉ bits .$$

In one example, at least one of the following examples is used/configured regarding the groups/subsets of antenna ports when the number of transmission layers (rank)>1.
In one example, the group/subset of n antenna ports is selected common for all layers (i.e., layer-common group), hence all layers are transmitted from the same (selected) group/subset of antenna ports.
In one example, the group/subset of n antenna ports is selected independently/specifically for each layer (i.e., layer-specific group), hence each layer is transmitted from its specific (independent) group/subset of antenna ports.
In one example, the group/subset of n antenna ports is selected independently/specifically for each layer-pair (i.e., layer-pair-specific group), hence each layer pair (l, l+1) is transmitted from its specific (independent) group/subset of antenna ports. In one example, layer pairs comprises (1,2), (3,4), . . . etc.
In one example, it is a combination of the first two examples, i.e., at least a first group of the G groups/subsets is selected common for multiple layers, and at least a second group of the G groups/subsets is selected specifically for a layer (different from the multiple layers). Or a first subset of the G groups are common for a first subset of all layers and a second subset of the G groups are common for a second subset of all layers, where the first and second subsets are different.
In one example, a number of layers associated group gᵢ=lᵢ, where lᵢ∈{0, 1, . . . , nᵢ} and Σᵢ₌₁^{G}lᵢ=L, where L is the number of layers. Here, lᵢ=0 denote that the group gᵢ is not selected for any layer of the UL transmission. When lᵢ=1, the group gᵢ is specific for a layer, and when lᵢ>1, the group gᵢ is common for multiple layers. In one example, the value of {lᵢ} is determined/indicated implicitly without any additional signaling, i.e., it is derived based on an existing signaling, e.g., TPMI and/or SRI. In one example, the value of {lᵢ} is indicated explicitly using a dedicated parameter, e.g., TRI or RI or LI or a new indicator.

In one example, at least one of the following examples is used/configured regarding the value of n.
In one example, n=N, i.e., all N antenna ports are selected (G=1), hence there is no need for indication of the indicator I. This is an example of a full-coherent (FC) UL transmission, and the indicator J indicates a FC precoding matrix, i.e., all N antenna ports can be used to transmit a transmission layer.
In one example, n=1, i.e., only 1 (out of N) antenna ports is selected (G=N), hence the indicator I indicates a port selection vector (comprising all 0s and only one 1 at the location of the selected antenna port). This is an example of a non-coherent (NC) UL transmission, and the indicator J indicates a fixed value 1, hence there is no need for indication of the indicator J. In this case, only 1 antenna port is used to transmit a transmission layer. Alternatively, the indicator I can be considered to be equal to the indicator J. Hence, only one of the two needs reporting.
In one example, n is a value from {2, . . . , N−1}, i.e., at least 2 and at most N−1 (not all N) antenna ports are selected, hence the indicator I indicates the group/subset of selected n antenna ports. This is an example of a partial-coherent (PC) UL transmission, and the indicator J indicates a PC precoding matrix, i.e., at least two but not all N antenna ports can be used to transmit a transmission layer. For example, when N≥8 and G∈{2, 4}, the UL transmission corresponds to a partial-coherent (PC) transmission using N/G antenna ports per layer.
In one example, the value of n can be n=N or n=1. When n=N, the transmission and the precoding matrices correspond to FC. When n=1, the transmission and the precoding matrices correspond to NC.
In one example, the value of n can be n=N or a value from {2, . . . , N−1}. When n=N, the transmission and the precoding matrices correspond to FC. When n is a value from {2, . . . , N−1}, the transmission and the precoding matrices correspond to PC.
In one example, the value of n can be n=1 or a value from {2, . . . , N−1}. When n=1, the transmission and the precoding matrices correspond to NC. When n is a value from {2, . . . , N−1}, the transmission and the precoding matrices correspond to PC.
In one example, the value of n can be n=1 or n=N or a value from {2, . . . , N−1}. When n=N, the transmission and the precoding matrices correspond to FC. When n=1, the transmission and the precoding matrices correspond to NC. When n is a value from {2, . . . , N−1}, the transmission and the precoding matrices correspond to PC.

In one example, one of the examples described herein is fixed (in specification). In one example, the UE is configured via higher layer (e.g., RRC) or MAC CE with one of the examples herein regarding the value of n. In one example, the UE is configured via higher layer (e.g., RRC) or MAC CE with one of the examples herein regarding the value of n or the value of G

$$( e . g . , G = \frac{N}{n} )$$

subject to a UE capability reporting. For instance,
for a UE reporting its capability of ‘nonCoherent’ can only be configured with one example herein,
for a UE reporting its capability of ‘partialCoherent’ can only be configured with one example herein,
for a UE reporting its capability of ‘fullCoherent’ can only be configured with one example herein,
for a UE reporting its capability of ‘nonAndFullCoherent’ can only be configured with certain examples herein,
for a UE reporting its capability of ‘nonAndPartialCoherent’ can only be configured with certain examples herein
for a UE reporting its capability of ‘partialAndFullCoherent’ can only be configured with certain examples herein, and
for a UE reporting its capability of ‘nonAndPartialAndFullCoherent’ can only be configured with certain examples herein.
for a UE reporting its capability of supporting two values of G, the two values include one of (1,2), (1,4), (2,4),
for a UE reporting its capability of supporting three values of G, the three values includes one of (1, 2, 4), (1, 4, 8), (1, 2, 8),
for a UE reporting its capability of supporting four values of G, the four values include (1, 2, 4, 8).

In one example, the existing higher layer parameter codebookSubset or codebookSubsetForDCI-Format0-2 is re-used for configuring one of the above examples (e.g., new values can be introduced for the examples above). In one example, a new higher layer parameter, e.g., codebookSubset-r18 or codebookSubsetForDCI-Format0-2-r18 is introduced.

In one example, the value of n can be configured directly via higher layer (RRC) or MAC CE or DCI. In one example, one or a set of values (multiple values) for n can be configured via higher layer (RRC) or MAC CE or DCI. In case of multiple values for n being configured, the UE is further indicated with one of the multiple values either via a separate indicator or via the indicator J (that indicates a precoding matrix) described above. In one example, the configuration or indication of the value of n is subject to a UE capability reporting, i.e., the UE reports the support of one or more values of n.

Likewise, in one example, the value of G can be configured directly via higher layer (RRC) or MAC CE or DCI. In one example, one or a set of values (multiple values) for G can be configured via higher layer (RRC) or MAC CE or DCI. In case of multiple values for G being configured, the UE is further indicated with one of the multiple values either via a separate indicator or via the indicator J (that indicates a precoding matrix) described above. In one example, the configuration or indication of the value of G is subject to a UE capability reporting, i.e., the UE reports the support of one or more values of G.

In one example, for a UE with N=2 antenna ports, the value of n can be n=1 or n=2. Hence, only NC or FC can be supported, i.e., only an example described herein where x belongs to {1, 2, 4} can be supported (or configured).

In one example, for a UE with N=4 antenna ports, the value of n can be according to at least one of the following examples:
In one example, n belongs to {2}.
In one example, n belongs to {1, 2}.
In one example, n belongs to {1, 2, 4}.
In one example, n belongs to {1, 2, 3, 4}.

In one example, for a UE with N=6 antenna ports, the value of n can be according to at least one of the following examples:
In one example, n belongs to {2, 4}.
In one example, n belongs to {1, 2, 4}.
In one example, n belongs to {1, 2, 4, 6}.
In one example, n belongs to {1, 2, 3, 4}.
In one example, n belongs to {1, . . . , 6}.

In one example, for a UE with N=8 antenna ports, the value of n can be according to at least one of the following examples:
In one example, n belongs to {2, 4}.
In one example, n belongs to {1, 2, 4}.
In one example, n belongs to {1, 2, 4, 6}.
In one example, n belongs to {1, 2, 4, 6, 8}.
In one example, n belongs to {1, 2, 4, 8}.
In one example, n belongs to {1, 2, 3, 4}.
In one example, n belongs to {1, . . . , 8}.

An example of subsets/groups of antenna ports for N=2 antenna ports is shown in Table 13, where there are three groups/subsets, hence the indicator I requires at most (or up to) 2 bits for indication.

An example of subsets/groups of antenna ports (selected freely) for N=4 antenna ports is shown in Table 14, where there are 15 groups/subsets, hence the indicator I requires at most (or up to) 4 bits for indication.

Two examples of subsets/groups of antenna ports (selected with restriction) for N=4 antenna ports are shown in Table 15, where there are 7 groups/subsets, hence the indicator I requires at most (or up to) 3 bits for indication.

Three examples of subsets/groups of antenna ports (selected with restriction) for N=8 antenna ports are shown in Table 16, where there are 15 groups/subsets, hence the indicator I requires at most (or up to) 4 bits for indication.

TABLE 13
subsets/groups of antenna ports for N = 2 antenna ports

| n | Subset/group of antenna ports |
|---|---|
| 1 | G₁⁽¹⁾ = {1} |
| | G₂⁽¹⁾ = {2} |
| 2 | G₁⁽²⁾ = {1, 2} |

TABLE 14
subsets/groups of antenna ports for N = 4 antenna ports

| n | Subset/group of antenna ports |
|---|---|
| 1 | G₁⁽¹⁾ = {1} |
| | G₂⁽¹⁾ = {2} |
| | G₃⁽¹⁾ = {3} |
| | G₄⁽¹⁾ = {4} |
| 2 | G₁⁽²⁾ = {1, 2} |
| | G₂⁽²⁾ = {1, 3} |
| | G₃⁽²⁾ = {1, 4} |
| | G₄⁽²⁾ = {2, 3} |
| | G₅⁽²⁾ = {2, 4} |
| | G₆⁽²⁾ = {3, 4} |
| 3 | G₁⁽³⁾ = {1, 2, 3} |
| | G₂⁽³⁾ = {1, 2, 4} |
| | G₃⁽³⁾ = {1, 3, 4} |
| | G₄⁽³⁾ = {2, 3, 4} |
| 4 | G₁⁽⁴⁾ = {1, 2, 3, 4} |

TABLE 15
subsets/groups of antenna ports for N = 4 antenna ports

| | Subset/group of antenna | Subset/group of antenna |
|---|---|---|
| n | ports: Ex1 | ports: Ex2 |
| 1 | G₁⁽¹⁾ = {1} | G₁⁽¹⁾ = {1} |
| | G₂⁽¹⁾ = {2} | G₂⁽¹⁾ = {2} |
| | G₃⁽¹⁾ = {3} | G₃⁽¹⁾ = {3} |
| | G₄⁽¹⁾ = {4} | G₄⁽¹⁾ = {4} |
| 2 | G₁⁽²⁾ = {1, 2} | G₂⁽²⁾ = {1, 3} |
| | G₆⁽²⁾ = {3, 4} | G₅⁽²⁾ = {2, 4} |
| 4 | G₁⁽⁴⁾ = {1, 2, 3, 4} | G₁⁽⁴⁾ = {1, 2, 3, 4} |

TABLE 16
subsets/groups of antenna ports for N = 8 antenna ports

| | Subset/group of | Subset/group of | Subset/group of |
|---|---|---|---|
| n | antenna ports: Ex1 | antenna ports: Ex2 | antenna ports: Ex3 |
| 1 | $\begin{matrix}{G}_{1}^{( 1 )} = \{ 1 \} \\ {G}_{2}^{( 1 )} = \{ 2 \} \\ ⋮ \\ {G}_{8}^{( 1 )} = \{ 8 \}\end{matrix}$ | $\begin{matrix}{G}_{1}^{( 1 )} = \{ 1 \} \\ {G}_{2}^{( 1 )} = \{ 2 \} \\ ⋮ \\ {G}_{8}^{( 1 )} = \{ 8 \}\end{matrix}$ | $\begin{matrix}{G}_{1}^{( 1 )} = \{ 1 \} \\ {G}_{2}^{( 1 )} = \{ 2 \} \\ ⋮ \\ {G}_{8}^{( 1 )} = \{ 8 \}\end{matrix}$ |
| 2 | G₁⁽²⁾ = {1, 2} | G₁⁽²⁾ = {1, 3} | G₁⁽²⁾ = {1, 5} |
| | G₂⁽²⁾ = {3, 4} | G₂⁽²⁾ = {2, 4} | G₂⁽²⁾ = {2, 6} |
| | G₃⁽²⁾ = {5, 6} | G₃⁽²⁾ = {5, 7} | G₃⁽²⁾ = {3, 7} |
| | G₄⁽²⁾ = {7, 8} | G₄⁽²⁾ = {6, 8} | G₄⁽²⁾ = {4, 8} |
| 4 | G₁⁽⁴⁾ = {1, 2, 3, 4} | G₁⁽⁴⁾ = {1, 3, 5, 7} | G₁⁽⁴⁾ = {1, 2, 5, 6} |
| | G₂⁽⁴⁾ = {5, 6, 7, 8} | G₂⁽⁴⁾ = {2, 4, 6, 8} | G₂⁽⁴⁾ = {3, 4, 7, 8} |
| 8 | G₁⁽⁸⁾ = | G₁⁽⁸⁾ = | G₁⁽⁸⁾ = |
| | {1, 2, . . . , 8} | {1, 2, . . . , 8} | {1, 2, . . . , 8} |

In one example, the indicator I (as described above) corresponds to (or associated with) an SRI or a component of SRI (when SRI comprises multiple components) or TPMI/TRI or a component of TPMI/TRI (when TPMI/TRI comprises multiple components) or a new indicator or two components of a new indicator (when the new indicator comprises multiple components).

In one example, the indicator J (as described above) corresponds to (or associated with) an SRI or a component of SRI (when SRI comprises multiple components) or TPMI/TRI or a component of TPMI/TRI (when TPMI/TRI comprises multiple components) or a new indicator or two components of a new indicator (when the new indicator comprises multiple components).

For the case of PC or FC, there are two indicators, I and J (as described above). The two indicators correspond to (or associated with) an SRI or two components of SRI (when SRI comprises multiple components) or TPMI/TRI or two components of TPMI/TRI (when TPMI/TRI comprises multiple components) or a new indicator or two components of a new indicator (when the new indicator comprises multiple components). Or the two indicators correspond to (or associated with) an SRI, and a TPMI, respectively.

In one example, for PC, the indicator I indicates one group/subset of antenna ports for each layer. When the number of layers>1, the same group or different groups can be indicated across layers.

In one example, for FC, the indicator I indicates one of the following two examples of groups/subsets.
In one example, the indicator I indicates one group/subset comprising n=N antenna ports for all layers.
In one example, the indicator I indicates multiple subsets/groups (e.g., 2) for a layer. When the number of layers>1, the same groups or different groups can be indicated across layers. There could additional indication about co-phasing across groups and/or amplitude/power across multiple subsets/groups. This additional indication can be together with the indicator I or j or via a separate (new) indicator.

In one example, for NC, there is only one indicator, either I or J (not both), as described above. This is akin to non-codebook-based UL transmission in Rel.15 NR specification.

In one example, a group/subset of n antenna ports corresponds to (or maps to or is associated with) an antenna panel at the UE (e.g., for a multi-panel UE, there are multiple groups). In this case, the selection of a group/subset of antenna ports is essentially functionally equivalent to a selection of an antenna panel.

In one example, the scope or the applicability of the above-mentioned scheme is restricted according to at least one of the following examples.
In one example (R1), the scope or the applicability of the above-mentioned scheme is restricted to >4Tx UL operations, i.e., for UE's with more than 4 (e.g., 6 or 8) antenna ports. That is, the above-mentioned scheme can only be configured to a UE with >4 antenna ports (such a configuration can be subject to a UE capability reporting about the support for >4 antenna ports).
In one example (R2), the scope or the applicability of the above-mentioned scheme is restricted to UEs with multiple antenna panels. That is, the above-mentioned scheme can only be configured to a UE with multiple antenna panels (such a configuration can be subject to a UE capability reporting about the support for multiple antenna panels at the UE).
In one example (R3), the scope or the applicability of the above-mentioned scheme is restricted to UL transmission to multiple TRPs (e.g., 2 TRPs). That is, the above-mentioned scheme can only be configured to a UE which can transmit to multiple TRPs (such a configuration can be subject to a UE capability reporting about the support for UL transmission to multiple TRPs).
In one example (R4), the scope or the applicability of the above-mentioned scheme is restricted according to two restrictions (Rx, Ry), where x≠y and x and y belong to {1, 2, 3}.
In one example (R5), the scope or the applicability of the above-mentioned scheme is restricted according to all three restrictions, R1, R2, and R3.

In one embodiment, the UL transmission scheme according to embodiments described herein can be described based on the value n. When n>1, the UL transmission scheme can be described as a codebook-based scheme since it requires an indication of the indicator J (e.g., TPMI/TRI) in addition to the indication of the indicator I (e.g., SRI). This is akin to codebook-based UL transmission in NR specification (section 6.1.1.1 of TS 38.214). When n=1, the UL transmission scheme can be described as a non-codebook-based scheme since it does not require an indication of the indicator J (for the precoding matrix). This is akin to non-codebook-based UL transmission in NR specification (section 6.1.1.2 of TS 38.214). In other words, there is one unified UL transmission scheme (not two) which includes both codebook-based and non-codebook-based schemes based on the value of n. When the UE can be indicated with a group with n=1 or n>1, the UL transmission corresponds to a combination of a CB-based transmission and a non-CB-based transmission.

Alternatively, this scheme can be described as a combination (or hybrid) of both codebook-based and non-codebook-based schemes. The component for the selection/indication of group/subset of antenna ports is a generalization of non-codebook-based part of the scheme, and the component for the selection/indication of the precoding matrix corresponds to the codebook-based part of the scheme. The indicator for the non-codebook-based part of the scheme is the indicator I (e.g., SRI), and the indicator for the codebook-based part of the scheme is the indicator J (e.g., TPMI/TRI).

In one embodiment, at least one of the following examples is used/configured regarding the codebook for the indicator J (e.g., TPMI/TRI).
In one example, the codebook is a legacy (Rel. 15-17) codebook in NR specification. For 2 antenna ports, the codebook can be Rel. 15 NR UL codebook for 2 antenna ports, or includes a subset of precoding matrices from Rel. 15 NR UL codebook for 2 antenna ports. For 4 antenna ports, the codebook can be Rel. 15 UL codebook for 4 antenna ports, or Rel. 15 DL Type I codebook for 4 antenna ports, or includes a subset of precoding matrices from Rel. 15 NR UL codebook or Rel. 15 DL Type I codebook for 4 antenna ports. For 8 antenna ports, the codebook can be Rel. 15 DL Type I codebook for 8 antenna ports, or includes a subset of precoding matrices from Rel. 15 NR DL Type I codebook for 8 antenna ports.
In one example, the codebook is a new codebook. Some examples of the new codebook are as described in the U.S. provisional patent application 63/246,598 filed on Sep. 21, 2021.

In one embodiment, a UE equipped with N>4 antenna ports (e.g., 6 or 8 antenna ports) is configured with an UL transmission according to the scheme described herein.

In one example, the value of n≤4. In one example, the value of n∈{2, 4}. In one example, the value of n∈{1, 2, 4}. In one example, the value of n∈{1, 2, 4, 8}. In one example, the value of n is fixed (e.g., 2).

When n=8 and N=8, the indicator I (e.g., SRI) indicates a selection of a group/subset of n=8 antenna ports (i.e., all ports are included in the group). In one example, the number of groups

$$G = \frac{N}{n} = 1 , or n = \frac{N}{G} = 8. Since n = 8 ,$$

a codebook for 8 antenna ports is needed for the indicator J. In one example, the codebook includes all of or a subset of Rel. 15 NR DL Type I single panel codebook for 8 antenna ports. In one example, the codebook includes all of or a subset of Rel. 15 NR DL Type I multi-panel codebook for 8 antenna ports.

When n=4 and N=8, the indicator I (e.g., SRI) indicates a selection of a group/subset of n=4 antenna ports. In one example, the number of groups

$$G = \frac{N}{n} = 2 , or n = \frac{N}{G} = 4.$$

In one example, the selection corresponds to a free selection, i.e., any 4 out of 8 antenna ports are selected. The indicator indicating this selection can be a bitmap (sequence) of length 8 bits (or 4 bits), or a combinatorial index with payload

$$⌈ {log}_{2} ( \begin{matrix}8 \\ 4\end{matrix} ) ⌉ bits .$$

$$( or ⌈ {log}_{2} ( \begin{matrix}4 \\ 2\end{matrix} ) ⌉ ) ,$$

as described herein.
In one example, the selection corresponds to a restriction selection. In one example, there are two possible subsets/groups g₁=G₁⁽⁴⁾={1, . . . , 4} and g₂=G₂⁽⁴⁾={5, . . . , 8}, and hence a 1-bit indicator I is needed. In one example, there are two possible subsets/groups g₁=G₁⁽⁴⁾={1, 3, 5, 7} and g₂=G₂⁽⁴⁾={2, 4, 6, 8}, and hence a 1-bit indicator I is needed.

Since n=4, a codebook for 4 antenna ports is needed for the indicator J. In one example, the codebook includes all of or a subset of Rel. 15 NR UL codebook or Rel. 15 NR DL Type I codebook for 4 antenna ports. In one example, the codebook includes all of or a subset of the full coherent precoding matrices in the Rel. 15 NR UL codebook for 4 antenna ports.

When n=2 and N=8, the indicator I (e.g., SRI) indicates a selection of a group/subset of n=2 antenna ports. In one example, the number of groups

$$G = \frac{N}{n} = 4 , or n = \frac{N}{G} = 2.$$

In one example, the selection corresponds to a free selection, i.e., any 2 out of 8 antenna ports are selected. The indicator indicating this selection can be a bitmap (sequence) of length 8 bits (or 4 bits), or a combinatorial index with payload

$$⌈ {log}_{2} ( \begin{matrix}8 \\ 2\end{matrix} ) ⌉ bits ( or ⌈ {log}_{2} ( \begin{matrix}4 \\ 1\end{matrix} ) ⌉ ,$$

as described herein.
In one example, the selection corresponds to a restriction selection. In one example, there are four possible subsets/groups g₁=G₁⁽²⁾={1, 2}, g₂=G₂⁽²⁾={3, 4}, g₃=G₃⁽²⁾={5, 6}, and g₄=G₄⁽²⁾={7, 8}, and hence a 2-bit indicator I is needed. In one example, there are four possible subsets/groups g₁=G₁⁽²⁾={1, 3}, g₂=G₂⁽²⁾={2, 4}, g₃=G₃⁽²⁾={5, 7}, and g₄=G₄⁽²⁾={6, 8}, and hence a 2-bit indicator I is needed. In one example, there are four possible subsets/groups g₁=G₁⁽²⁾={1, 5}, g₂=G₂⁽²⁾={2, 6}, g₃=G₃⁽²⁾={3, 7}, and g₄=G₄⁽²⁾={4, 8}, and hence a 2-bit indicator I is needed.

Since n=2, a codebook for 2 antenna ports is needed for the indicator J. In one example, the codebook includes all of or a subset of Rel. 15 NR UL codebook or Rel. 15 NR DL Type I codebook for 2 antenna ports. In one example, the codebook includes all of or a subset of the partial coherent precoding matrices in the Rel. 15 NR UL codebook for 4 antenna ports.

When n=1 and N=8, the indicator I (e.g., SRI) indicates a selection of a group/subset of n=1 antenna port. In one example, the number of groups

$$G = \frac{N}{n} = 8 , or n = \frac{N}{G} = 1.$$

When n=2 and N=6, the indicator I (e.g., SRI) indicates a selection of a group/subset of n=2 antenna ports.
In one example, the selection corresponds to a free selection, i.e., any 2 out of 6 antenna ports are selected. The indicator indicating this selection can be a bitmap (sequence) of length 6 bits (or 3 bits), or a combinatorial index with payload

$$⌈ {log}_{2} ( \begin{matrix}6 \\ 2\end{matrix} ) ⌉ bits .$$

$$( or ⌈ {log}_{2} ( \begin{matrix}3 \\ 1\end{matrix} ) ⌉ ) ,$$

as described herein.
In one example, the selection corresponds to a restriction selection. In one example, there are three possible subsets/groups G₁⁽²⁾={1, 2}, G₂⁽²⁾={3, 4}, G₃⁽²⁾={5, 6}, and hence a 2-bit indicator I is needed. In one example, there are three possible subsets/groups G₁⁽²⁾={1, 4}, G₂⁽²⁾={2, 5}, G₃⁽²⁾={3, 6}, and hence a 2-bit indicator I is needed.

Since n=2, a codebook for 2 antenna ports is needed for the indicator J. In one example, the codebook is Rel. 15 NR UL codebook or Rel. 15 NR DL Type I codebook for 2 antenna ports. In one example, the codebook includes all of or a subset of the partial coherent precoding matrices in the Rel. 15 NR UL codebook for 4 antenna ports and full-coherent precoding matrices in the Rel. 15 NR UL codebook for 2 antenna ports.

In one embodiment, wherein the UE is indicated with multiple groups/subsets of antenna ports selected from a total of N antenna ports at the UE, each group/subset includes the same number (n) of antenna ports. In one example, group/subset gᵢ includes nᵢ antenna port, where i is the index of the i-the group/subset gᵢ, nᵢ is the number of antenna ports in the i-th group, and i∈{1, . . . , G}, where G is the number of groups, and nᵢ value for different i can be the same or different. In one example,

$${n}_{i} = \frac{N}{G} .$$

In one example, G is fixed (e.g., 2). In one example, G is configured, e.g., via higher layer (RRC) or MAC CE or DCI. In one example, the UE reports its capability about the supported value(s) of G. In one example,

$$i = 1 , … , G , N ∈ \{ 2 , 4 , 6 , 8 , 12 , 16 \} , \\ G ∈ \{ 1 , 2 , 3 , 4 , 6 , 8 , 12 , 16 \} , G \leq N , and {n}_{i} = \frac{N}{G} .$$

In one example, when N=2, G∈{1, 2}.
In one example, when N=4, G∈{1, 2, 4}.
In one example, when N=6, G∈{1, 2, 3}.
In one example, when N=8, G∈{1, 2, 4, 8}.
In one example, when N=12, G∈{1, 2, 4, 6, 12}.
In one example, when N=16, G∈{1, 2, 4, 8, 16}.

Note that when antenna group/subset corresponds to an antenna panel at the UE and G>1, the UL transmission corresponds to STxMP (simultaneous transmission from multiple antenna panels, when more than one of the G groups is used for UL transmission) and/or single panel transmission (when one of the G groups is used for UL transmission).

In one example, there is one joint indicator I indicating the selected G groups/subsets of antenna ports. In one example, the indicator I comprise components I₁, . . . I_{G} where Iᵢ indicates the i-th group/subset.

In one example, when N=4, the value G can be 1 or 2 or 4.
When G=1, the indicator I indicates the one group comprising all 4 ports, and the UL transmission is based on the one group.
When G=2, the indicator I indicates the two groups/subsets of the 4 ports, and the UL transmission is based on one of or both of the two groups.
When G=4, the indicator I indicates the four groups/subsets of the 4 ports, and the UL transmission is based on one of or 2, 3, or 4 groups/subsets.

In one example, there is an UL codebook for each group, which can be legacy (Rel. 15 UL codebook or Rel. 15 DL Type I codebook). In addition, there could a codebook for additional components such inter-group amplitude/power and/or phase.

In one example, when G>1, there is one codebook which includes
Intra-group components: components for each group, e.g., DFT basis vector(s), phase, amplitude
Inter-group components: components across groups, e.g., amplitude/power and/or phase value

In one example, when N=2, the value G can be 1 or 2.
When G=1, the indicator I indicates the one group comprising all 2 ports, and the UL transmission is based on the one group.
When G=2, the indicator I indicates the two groups/subsets of the 2 ports, and the UL transmission is based on one of or both of the two groups.

In one example, there is an UL codebook for each group, which can be legacy (Rel. 15 UL codebook or Rel. 15 DL Type I codebook). In addition, there could a codebook for additional components such inter-group amplitude/power and/or phase.

In one example, when G>1, there is one codebook which includes
Intra-group components: components for each group, e.g., DFT basis vector(s), phase, amplitude
Inter-group components: components across groups, e.g., amplitude/power and/or phase value

In one example, when N=8, the value G can be 1 or 2 or 4 or 8.
When G=1, the indicator I indicates the one group comprising all 8 ports, and the UL transmission is based on the one group.
When G=2, the indicator I indicates the two groups/subsets, each comprising 8/2=4 ports, and the UL transmission is based on one of or both of the two groups.
When G=4, the indicator I indicates the four groups/subsets, each comprising 8/4=2 ports, and the UL transmission is based on one of or 2, 3, or 4 groups/subsets.
When G=8, the indicator I indicates the 8 groups/subsets, each comprising 8/8=1 port, and the UL transmission is based on one of or 2, 3, or 4, . . . , or 8 groups/subsets.

In one example, there is an UL codebook for each group, which can be legacy (Rel. 15 UL codebook or Rel. 15 DL Type I codebook). In addition, there could a codebook for additional components such inter-group amplitude/power and/or phase.

In one example, when G>1, there is one codebook which includes
Intra-group components: components for each group, e.g., DFT basis vector(s), phase, amplitude
Inter-group components: components across groups, e.g., amplitude/power and/or phase value

In one embodiment, the UE is indicated with one or multiple groups/subsets of antenna ports selected from a total of N antenna ports at the UE. In one example, each group/subset includes the same number (n) of antenna ports. In one example, group/subset gᵢ includes nᵢ antenna port, where i is the index of the i-the group/subset gᵢ, nᵢ is the number of antenna ports in the i-th group, and i∈{1, . . . , G}, where G is the number of groups, and nᵢ value for different i can be the same or different. In one example,

$${n}_{i} = \frac{N}{G} .$$

In one example, G is fixed (e.g., 1 or 2). In one example, G is configured, e.g., via higher layer (RRC) or MAC CE or DCI. In one example, the UE reports its capability about the supported value(s) of G. In one example,

$$i = 1 , … , G , N ∈ \{ 2 , 4 , 6 , 8 , 12 , 16 \} , \\ G ∈ \{ 1 , 2 , 3 , 4 , 6 , 8 , 12 , 16 \} , G \leq N , and {n}_{i} = \frac{N}{G} .$$

In one example, when N=2, G∈{1, 2}.
In one example, when N=4, G∈{1, 2, 4}.
In one example, when N=6, G∈{1, 2, 3}.
In one example, when N=8, G∈{1, 2, 4, 8}.
In one example, when N=12, G∈{1, 2, 4, 6, 12}.
In one example, when N=16, G∈{1, 2, 4, 8, 16}.

Note that when antenna group/subset corresponds to an antenna panel at the UE and G>1, the UL transmission corresponds to STxMP (simultaneous transmission from multiple antenna panels) when G>1 and the UL transmission corresponds to SP (single panel) transmission when G=1.

In one example, there is one joint indicator I indicating the selected G groups/subsets of antenna ports. In one example, the indicator I comprise components I₁, . . . I_{G} where Iᵢ indicates the i-th group/subset.

In one example, when N=4, the value G can be 1, 2 or 4.
When G=1, the indicator I indicates the one group comprising all 4 ports, and the UL transmission is based on the one group.
When G=2, the indicator I indicates the two groups/subsets of the 4 ports, and the UL transmission is based on one of or both of the two groups.
When G=4, the indicator I indicates the four groups/subsets of the 4 ports, and the UL transmission is based on one of or 2, 3, or 4 groups/subsets.

When G=1, the UL codebook is according to one of the examples from embodiments described herein.

In one example, when G>1, there is an UL codebook for each group, which can be legacy (Rel. 15 UL codebook or Rel. 15 DL Type I codebook). In addition, there could a codebook for additional components such inter-group amplitude/power and/or phase.

In one example, when G>1, there is one codebook which includes
Intra-group components: components for each group, e.g., DFT basis vector(s), phase, amplitude
Inter-group components: components across groups, e.g., amplitude/power and/or phase value

In one example, when N=2, the value G can be 1 or 2.
When G=1, the indicator I indicates the one group/subset for the UL transmission.
When G=2, the indicator I indicates the two groups/subsets for the UL transmission.

When G=1, the UL codebook is according to one examples from embodiments described herein.

In one example, when G>1, there is an UL codebook for each group, which can be legacy (Rel. 15 UL codebook or Rel. 15 DL Type I codebook). In addition, there could a codebook for additional components such inter-group amplitude/power and/or phase.

In one example, when G>1, there is one codebook which includes
Intra-group components: components for each group, e.g., DFT basis vector(s), phase, amplitude
Inter-group components: components across groups, e.g., amplitude/power and/or phase value

In one example, when N=8, the value G can be 1 or 2 or 4 or 8.
When G=1, the indicator I indicates the one group comprising all 8 ports, and the UL transmission is based on the one group.
When G=2, the indicator I indicates the two groups/subsets, each comprising 8/2=4 ports, and the UL transmission is based on one of or both of the two groups.
When G=4, the indicator I indicates the four groups/subsets, each comprising 8/4=2 ports, and the UL transmission is based on one of or 2, 3, or 4 groups/subsets.
When G=8, the indicator I indicates the 8 groups/subsets, each comprising 8/8=1 port, and the UL transmission is based on one of or 2, 3, or 4, . . . , or 8 groups/subsets.

When G=1, the UL codebook is according to one of the examples described herein,

In one example, when G>1, there is an UL codebook for each group, which can be legacy (Rel. 15 UL codebook or Rel. 15 DL Type I codebook). In addition, there could a codebook for additional components such inter-group amplitude/power and/or phase.

In one example, when G>1, there is one codebook which includes
Intra-group components: components for each group, e.g., DFT basis vector(s), phase, amplitude
Inter-group components: components across groups, e.g., amplitude/power and/or phase value

In one embodiment, which is an extension of the above embodiments, a UE is indicated with one or multiple groups/subsets of antenna ports selected from a total of N antenna ports at the UE for the UL transmission to multiple TRPs (mTRPs), e.g., the UL transmission corresponds to multiple (e.g., 2) PUSCHs. Let T be the number of TRPs. In one example, T is fixed (e.g., 2). In one example, T is configured (e.g., via higher layer, or MAC CE or DCI). In one example, a max value of T or a set of supported values of T is reported by the UE via UE capability.

In one example, the UL transmission scheme for the case of two TRPs is as described in Section 6.1.2.1 of TS 38.214, wherein there are two separate UL (e.g., PUSCH) transmission, one for each TRP.

In one example, at least one of the following examples is used/configured regarding the indicator I.
In one example, the selection of one group/subset or multiple groups/subsets is indicated separately per TRP. In one example, I=(I₁, . . . I_{T}), where T is the number of TRPs, and Iₜ is the indicator for the t-th TRP.
In one example, the selection of one group/subset or multiple groups/subsets is indicated jointly via one indicator.

When there are separate indicators, they can be indicated via the same or different medium/channel, where the medium/channel corresponds to RRC, MAC CE, or DCI.

In one example, at least one of the following examples is used/configured regarding the indicator J.
In one example, the selection of one group/subset or multiple groups/subsets is indicated separately per TRP. In one example, J=(J₁, . . . J_{T}), where T is the number of TRPs, and Jₜ is the indicator for the t-th TRP.
In one example, the selection of one group/subset or multiple groups/subsets is indicated jointly via one indicator.

When there are separate indicators, they can be indicated via the same or different medium/channel, where the medium/channel corresponds to RRC, MAC CE, or DCI.

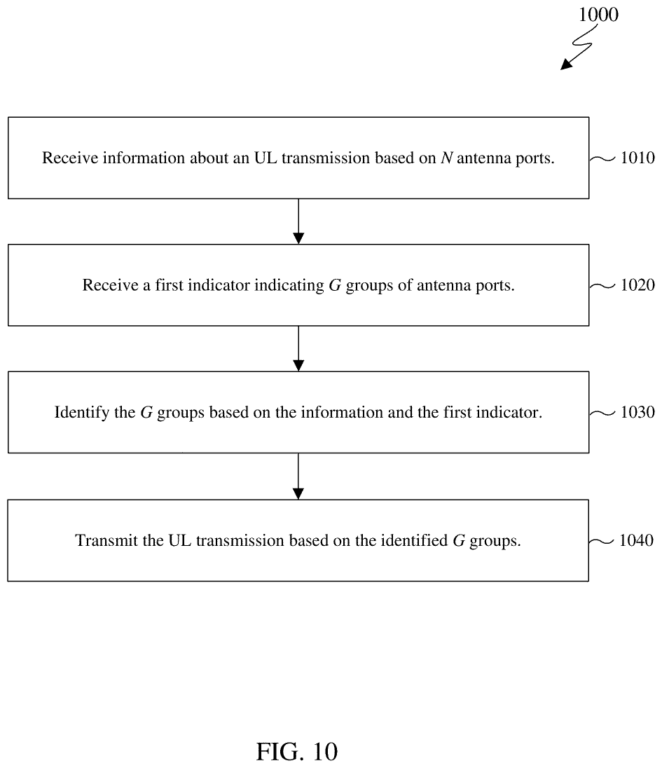

FIG. 10 illustrates an example method 1000 for uplink transmission in a wireless communication system according to embodiments of the present disclosure. The steps of the method 1000 of FIG. 10 can be performed by any of the UEs 111-116 of FIG. 1, such as the UE 116 of FIG. 3, and a corresponding method may be performed by a BS, such as BS 101-103. The method 1000 is for illustration only and other embodiments can be used without departing from the scope of the present disclosure.

The method begins with the UE receiving information about an UL transmission based on N antenna ports (step 1010). In one example, the information includes multiple values for G. The UE then receives a first indicator (I) indicating G groups of antenna ports, g₁, . . . , g_{G} (step 1020). For example, in step 1020, the group gᵢ includes nᵢ antenna ports selected from the N antenna ports, wherein

$$i = 1 , … , G , N ∈ \{ 2 , 4 , 6 , 8 , 12 , 16 \} , \\ G ∈ \{ 1 , 2 , 3 , 4 , 6 , 8 , 12 , 16 \} , G \leq N , and {n}_{i} = \frac{N}{G} .$$

In various embodiments, the first indicator (I) is associated with a sounding reference SRI or a TPMI. In various embodiments, the UE may have transmitted UE capability information indicating support of one or multiple values of G.

In various embodiments, the UE may also receive a second indicator (J) indicating a precoding matrix and a number of layers that are associated with the UL transmission. For example, the first indicator (I) and the second indicator (J) may be encoded in one of a joint field of a medium where the joint field is associated with a SRI or a TPMI, two separate fields of the medium where the two separate fields are associated with the SRI and the TPMI, respectively, or two separate mediums, where the medium is one of a RRC message, a MAC-CE, or a DCI. In some examples, the two separate mediums correspond to two mediums selected from a group including the RRC message, the MAC CE, and the DCI. In various embodiments, the first indicator (I) indicates the G groups corresponding to one of the multiple values of G. For example, when the multiple values are two, the two values are one of (1, 2), (1, 4), (2, 4); when the multiple values are three, the three values are one of (1, 2, 4), (1, 4, 8), (1, 2, 8); and when the multiple values are four, the four values are (1, 2, 4, 8).

The UE then identifies, based on the information and the first indicator (I), the G groups, (step 1030). For example, in step 1030, when the number of layers is more than one: the G groups are common for all layers, each layer is associated with one of the G groups, or a first subset of the G groups are common for a first subset of all layers and a second subset of the G groups are common for a second subset of all layers, where the first and second subsets are different.

The UE then transmits the UL transmission based on the identified G groups. (step 1040). For example, in step 1040, the UE may transmit the UL transmission based on the identified G groups, the precoding matrix, and the number of layers. For example, when N≥8 and G=1, the UL transmission corresponds to a FC transmission using all of the N antenna ports per layer; when N≥8 and G∈{2, 4}, the UL transmission corresponds to a PC transmission using N/G antenna ports per layer; and when N≥8 and G=N, the UL transmission corresponds to a NC transmission using one of the N antenna ports per layer. In various embodiments, the UL transmission corresponds to one of: a CB-based transmission, when nᵢ>1; an NCB-based transmission, nᵢ=1; or a combination of the CB-based transmission and the NCB-based transmission, when at least one nᵢ=1 and at least one other nᵢ>1. In various embodiments, the UL transmission corresponds to T>1 PUSCHs and the first indicator (I) indicates Gₜ groups for a t-th PUSCH from the PUSCHs, where t=1, . . . , T.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to:
receive information about an uplink (UL) transmission based on N antenna ports, and
receive a first indicator (I) indicating G groups of antenna ports, g₁, . . . , g_{G}, where group gᵢ includes nᵢ antenna ports selected from the N antenna ports; and
a processor operably coupled to the transceiver, the processor configured to identify, based on the information and the first indicator (I), the G groups,
wherein the transceiver is further configured to transmit the UL transmission based on the identified G groups, and
wherein
$$i = 1 , … , G , N ∈ \{ 2 , 4 , 6 , 8 , 12 , 16 \} , \\ G ∈ \{ 1 , 2 , 3 , 4 , 6 , 8 , 12 , 16 \} , G \leq N , and {n}_{i} = \frac{N}{G} .$$

2. The UE of claim 1, wherein the first indicator (I) is associated with a sounding reference signal resource indicator (SRI) or a transmit precoding matrix indicator (TPMI).

3. The UE of claim 1, wherein:
the transceiver is further configured to:
receive a second indicator (J) indicating a precoding matrix and a number of layers that are associated with the UL transmission, and
transmit the UL transmission based on the identified G groups, the precoding matrix, and the number of layers,
the first indicator (I) and the second indicator (J) are encoded in one of a joint field of a medium, two separate fields of the medium, or two separate mediums,
the joint field is associated with a sounding reference signal resource indicator (SRI) or a transmit precoding matrix indicator (TPMI),
the two separate fields are associated with the SRI and the TPMI, respectively,
the medium is one of a radio resource control (RRC) message, a medium access control-control element (MAC-CE), or a downlink control information (DCI), and
the two separate mediums correspond to two mediums selected from a group including the RRC message, the MAC CE, and the DCI.

4. The UE of claim 3, wherein, when the number of layers is more than one:
the G groups are common for all layers,
each layer is associated with one of the G groups, or
a first subset of the G groups are common for a first subset of all layers and a second subset of the G groups are common for a second subset of all layers, where the first and second subsets are different.

5. The UE of claim 1, wherein:
when N≥8 and G=1, the UL transmission corresponds to a full-coherent (FC) transmission using all of the N antenna ports per layer,
when N≥8 and G∈{2, 4}, the UL transmission corresponds to a partial-coherent (PC) transmission using N/G antenna ports per layer, and
when N≥8 and G=N, the UL transmission corresponds to a non-coherent (NC) transmission using one of the N antenna ports per layer.

6. The UE of claim 5, wherein:
the information includes multiple values for G,
the first indicator (I) indicates the G groups corresponding to one of the multiple values of G,
when the multiple values are two, the two values are one of (1, 2), (1, 4), (2, 4),
when the multiple values are three, the three values are one of (1, 2, 4), (1, 4, 8), (1, 2, 8), and
when the multiple values are four, the four values are (1, 2, 4, 8).

7. The UE of claim 6, wherein the transceiver is further configured to transmit UE capability information including information related to support of one or multiple values of G.

8. The UE of claim 1, wherein the UL transmission corresponds to one of:
a codebook (CB)-based transmission, when nᵢ>1,
a non-codebook (NCB)-based transmission, nᵢ=1, or
a combination of the CB-based transmission and the NCB-based transmission, when at least one nᵢ=1 and at least one other nᵢ>1.

9. The UE of claim 1, wherein:
the UL transmission corresponds to T>1 physical uplink shared channels (PUSCHs), and
the first indicator (I) indicates Gₜ groups for a t-th PUSCH from the PUSCHs, where t=1, . . . , T.

10. A base station (BS) comprising:
a processor configured to generate information about an uplink (UL) transmission based on N antenna ports; and
a transceiver operably coupled to the processor, the transceiver configured to:
transmit the information,
transmit a first indicator (I) indicating G groups of antenna ports, g₁, . . . , g_{G}, where group gᵢ includes nᵢ antenna ports selected from the N antenna ports, and
receive the UL transmission,
wherein
$$i = 1 , … , G , N ∈ \{ 2 , 4 , 6 , 8 , 12 , 16 \} , \\ G ∈ \{ 1 , 2 , 3 , 4 , 6 , 8 , 12 , 16 \} , G \leq N , and {n}_{i} = \frac{N}{G} .$$

11. The BS of claim 10, wherein the first indicator (I) is associated with a sounding reference signal resource indicator (SRI) or a transmit precoding matrix indicator (TPMI).

12. The BS of claim 10, wherein:
the transceiver is further configured to:
transmit a second indicator (J) indicating a precoding matrix and a number of layers that are associated with the UL transmission,
the first indicator (I) and the second indicator (J) are encoded in one of a joint field of a medium, two separate fields of the medium, or two separate mediums,
the joint field is associated with a sounding reference signal resource indicator (SRI) or a transmit precoding matrix indicator (TPMI),
the two separate fields are associated with the SRI and the TPMI, respectively,
the medium is one of a radio resource control (RRC) message, a medium access control-control element (MAC-CE), or a downlink control information (DCI), and
the two separate mediums correspond to two mediums selected from a group including the RRC message, the MAC CE, and the DCI.

13. The BS of claim 12, wherein, when the number of layers is more than one:
the G groups are common for all layers,
each layer is associated with one of the G groups, or
a first subset of the G groups are common for a first subset of all layers and a second subset of the G groups are common for a second subset of all layers, where the first and second subsets are different.

14. The BS of claim 10, wherein:
when N≥8 and G=1, the UL transmission corresponds to a full-coherent (FC) transmission associated with all of the N antenna ports per layer,
when N≥8 and G∈{2, 4}, the UL transmission corresponds to a partial-coherent (PC) transmission associated with N/G antenna ports per layer, and
when N≥8 and G=N, the UL transmission corresponds to a non-coherent (NC) transmission associated with one of the N antenna ports per layer.

15. The BS of claim 14, wherein:
the information includes multiple values for G,
the first indicator (I) indicates the G groups corresponding to one of the multiple values of G,
when the multiple values are two, the two values are one of (1, 2), (1, 4), (2, 4),
when the multiple values are three, the three values are one of (1, 2, 4), (1, 4, 8), (1, 2, 8), and
when the multiple values are four, the four values are (1, 2, 4, 8).

16. A method for operating a user equipment (UE), the method comprising:
receiving information about an uplink (UL) transmission based on N antenna ports;
receiving a first indicator (I) indicating G groups of antenna ports, g₁, . . . , g_{G}, where group gᵢ includes nᵢ antenna ports selected from the N antenna ports;
identifying, based on the information and the first indicator (I), the G groups; and
transmitting the UL transmission based on the identified G groups,
wherein
$$i = 1 , … , G , N ∈ \{ 2 , 4 , 6 , 8 , 12 , 16 \} , \\ G ∈ \{ 1 , 2 , 3 , 4 , 6 , 8 , 12 , 16 \} , G \leq N , and {n}_{i} = \frac{N}{G} .$$

17. The method of claim 16, wherein the first indicator (I) is associated with a sounding reference signal resource indicator (SRI) or a transmit precoding matrix indicator (TPMI).

18. The method of claim 16, further comprising:
receiving a second indicator (J) indicating a precoding matrix and a number of layers that are associated with the UL transmission,
wherein:
transmitting the UL transmission further comprises transmitting the UL transmission based on the identified G groups, the precoding matrix, and the number of layers,
the first indicator (I) and the second indicator (J) are encoded in one of a joint field of a medium, two separate fields of the medium, or two separate mediums,
the joint field is associated with a sounding reference signal resource indicator (SRI) or a transmit precoding matrix indicator (TPMI),
the two separate fields are associated with the SRI and the TPMI, respectively,
the medium is one of a radio resource control (RRC) message, a medium access control-control element (MAC-CE), or a downlink control information (DCI), and
the two separate mediums correspond to two mediums selected from a group including the RRC message, the MAC CE, and the DCI.

19. The method of claim 18, wherein, when the number of layers is more than one:
the G groups are common for all layers,
each layer is associated with one of the G groups, or
a first subset of the G groups are common for a first subset of all layers and a second subset of the G groups are common for a second subset of all layers, where the first and second subsets are different.

20. The method of claim 16, wherein:
when N≥8 and G=1, the UL transmission corresponds to a full-coherent (FC) transmission using all of the N antenna ports per layer,
when N≥8 and G∈{2, 4}, the UL transmission corresponds to a partial-coherent (PC) transmission using N/G antenna ports per layer, and
when N≥8 and G=N, the UL transmission corresponds to a non-coherent (NC) transmission using one of the N antenna ports per layer.
